(19) United States
(12) Patent Application Publication
(10) Pub. No.: US 2008/0053484 A1
(43) Pub. Date: Mar. 6, 2008

(54) Apparatus and method for cleaning solids from a tank

(76) Inventor: Donald Roy Smith, Strathmore (CA)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/513,509

(22) Filed: Aug. 31, 2006

(51) Int. Cl. B08B 7/04; B08B 9/00

(52) U.S. Cl. 134/22.1; 134/10; 134/166 R

(57) ABSTRACT

A method and system for removing solid materials from an oil production tank containing a liquid hydrocarbon portion and a solid portion is provided. The system includes an intake for drawing off a portion of the liquid hydrocarbon and a solid portions from the tank. A rotational particle separator receives the portion of the liquid hydrocarbon and the solid portions from the intake. A collector is provided for collecting the separated solid portion, and a return returns the separated liquid hydrocarbon portion to the tank. The system and method avoid the wasteful disposal of oil with the solid material from the oil production tank.

### BACKGROUND OF THE INVENTION

1. Field of Invention

The present invention relates to removing solids from a tank in general, and in particular to a method and apparatus for removing solid particles from an oil production tank.

2. Description of Related Art

In the collection of oil from oil wells, it is common to employ a storage tank or production tank at a well or another location. Such production tanks may be used to perform a processing stage on the crude oil or as a means of temporary storage to account for different flow rates out of and away from the oil well.

In some areas, heavy oil wells are known to produce formation sand in varying percentages with cold oil production that is entrained with the heavy oil. Due to the decrease in velocity of the oil when located in a production tank, entrained sand and other solid material may be allowed to settle and accumulate on the bottom of the tank. These solid deposits accumulate in the bottom of the production tanks until the amount of sand deposited becomes problematic for the operator and the efficient operation of the production tank.

The accumulated solids may be removed from the tank on a periodic basis by a process that is commonly known as “stinging” the tank. A typical stinging operation requires a pressure truck, a stinger assembly and at least one vacuum truck. The pressure truck is connected via a pressure line to the stinger assembly, which is inserted into the bottom of the tank. The first vacuum truck connects to a “Suction Tee” located on a “Stuffing Box” of the stinger assembly. The pressure truck pumps water through the stinger assembly at low volume—high pressure directing the spray from the nozzle onto the floor of the production tank. The water utilized for this pumping operation can be either transported to the location with the pressure truck or can be drawn from an existing tank if it is available.

As the sand and settled solids inside the production tank are agitated or “fluidized” by the spray from the nozzle, the vacuum truck draws the fluid and solids from the production vessel via the “suction tee”. The slurry drawn from the tank is generally comprised of a mixture of sand, oil and water in varying percentages, however the sand/solid content is generally quite low (10-20% for example) of the total volume withdrawn. This mixture is then accumulated in a storage tank on the vacuum tank for disposal.

The typical method of cleaning a production tank as described above has several difficulties. The relatively small percentage of solid material in the total volume that must be disposed of results in a greater volume that is required to be transported away for disposal. This requires the use of several vacuum trucks so as to not interrupt the cleaning process unduly. Both of these factors increase the cost of the clean-out process over what would be necessary if only solid material was being removed and disposed of. The disposal of oil with the solid material is also wasteful resulting in lost production capacity.

What would be desirable is a method and apparatus for removing solid materials from an oil production tank that removes substantially only the solid materials and returns the oil to the tank.

### SUMMARY OF THE INVENTION

The present application provides a method and apparatus for removing solid materials from an oil production tank in which the solid material is separated from the oil and collected for disposal wherein the oil is returned to the production tank.

Accordingly, the present invention provides a method for removing solid materials from an oil production tank containing a liquid hydrocarbon portion and a solid portion, the method comprising
drawing off a portion of the liquid hydrocarbon and solid portions from the tank;
separating the liquid hydrocarbon and solid portions through the use of a rotational particle separator; and
collecting said separated solid portion, wherein said separated liquid hydrocarbon portion is returned to the tank.

In a further aspect, the present invention provides a system for removing solid materials from an oil production tank containing a liquid hydrocarbon portion and a solid portion, the apparatus comprising:
an intake for drawing off a portion of the liquid hydrocarbon and a solid portions from the tank;
a rotational particle separator adapted to receive said portion of the liquid hydrocarbon and a solid portions from said intake;
a collector for collecting said separated solid portion; and
a return for returning said separated liquid hydrocarbon portion to the tank.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Aspects of the present invention are illustrated merely by way of example in the following drawing in which:

FIG. 1 is a schematic diagram of the method of removing solids from an oil production tank in accordance with a first embodiment of the present invention.

### DETAILED DESCRIPTION

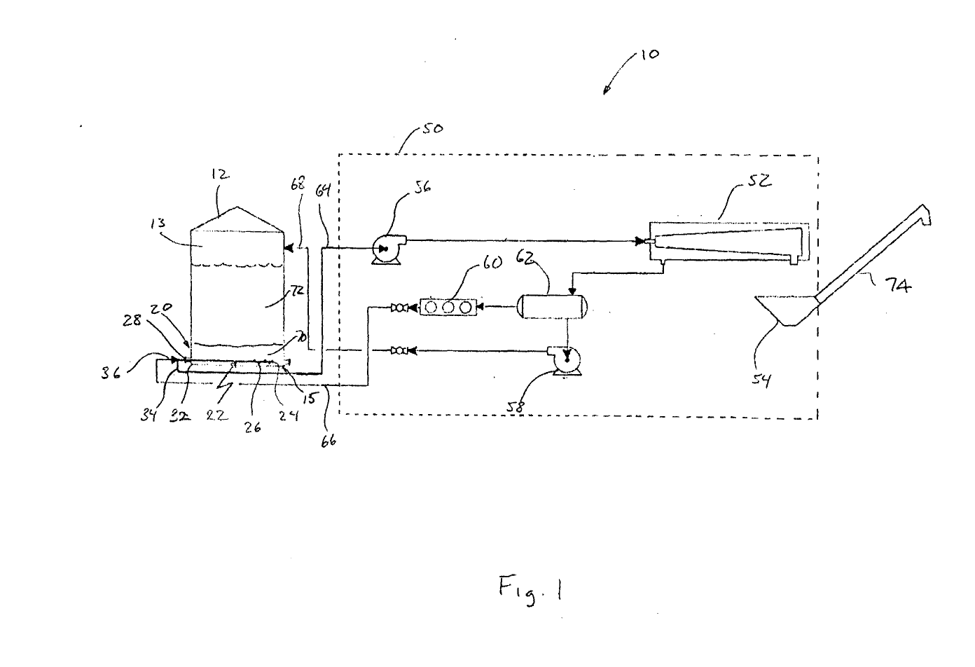

Referring to FIG. 1, a system for removing solid material from a oil production tank 12 having an interior 13 and a bottom 15 according to a first embodiment of the invention is shown generally at 10. The system 10 comprises a stinger assembly 20 which is insertable into the tank 12 and a separation system 50. The tank contains a solid portion 70 which may be settled on the bottom 15 and a liquid hydrocarbon portion 72.

The stinger assembly may be of a conventional design and comprises an elongate rod 22 or stinger having a distal end 24 and a central bore. The stinger 22 further includes a plurality of nozzles 26 adjacent to the distal end 24. The stinger assembly further includes a stinger insertion port or stuffing box 28 which attaches to an opening 32 of the tank and slidably and sealably permits the stinger to be inserted into the tank 12. The stuffing box 28 includes a suction connection 34 in fluidic communication with the interior 13 of the tank 12 and a pressure connection 36 in fluidic communication with the bore of the stinger 22.

The separation system 50 comprises a rotational particle separator 52 adapted to receive a solid and liquid mixture from the tank 12 and a collection bin 54 which receives the separated solid material from the rotational particle separator 52. The collection bin 54 may also have an associated conveyor 74 for removing the solid material from the collection bin 54 and delivery to a transport vehicle for disposing of the solid material. The conveyor 74 may comprise an auger, a conveyor belt or a downwardly inclined slide, for example. It will be appreciated that the rotational particle separator 52 may comprise a cyclone separator or a centrifuge, for example, or any other apparatus which separates solids from liquids through the use of centrifugal forces.

The separation system 50 may also include a suction pump 56, a return pump 58, a high pressure pump 60 and an accumulator tank 62. The suction pump 56 is connected to the suction connection 34 of the stuffing box 28 by suction line 64. The suction pump draws a mixture of the solid 70 and liquid portions 72 from the tank 12 and delivers it to the rotational particle separator 52.

The rotational particle separator 52 separates the solid portion 70 from the liquid portion 72 and delivers the liquid portion to the accumulator tank 62 while depositing the solid portion in the collection bin 54. The accumulator tank retains the liquid portion for return to the tank 12. A portion of the liquid may be delivered to the high pressure pump 60 for delivery to the pressure connection 36 of the stinger box 30 through pressure line 66. The remainder of the liquid in the accumulator tank 62 may be returned to the tank 12 by return pump 58 and return line 68. It will be appreciated that the separation system 50 may be mounted on a truck or a skid for ease of transpiration to a desired location.

As the fluid portion drawn off the tank 12 may include a fluidizing liquid, such as water, for example, as well as a liquid hydrocarbon drawn from the tank 12, the accumulator tank 62 may include both of these fluids as well. The fluid portion drawn from tank 12 is not necessarily separated into fluidizing liquid and hydrocarbon portions after processing through the rotational particle separator 52. The liquid portion delivered to accumulator tank 62 may be fluidizing liquid, hydrocarbon liquid or an emulsion of both if the liquids are immiscible. The outlets from the accumulator tank 62 are optionally positioned such that fluidizing liquid is passed through the high pressure pump 60 while the liquid hydrocarbon is passed through the return pump due to the stratification between these two liquids within the accumulator tank 62.

The high pressure pump 60 delivers a high pressure supply of fluidizing liquid to the stinger assembly 20 at high pressure where it is spayed out of nozzles 26. The high pressure spray from the nozzles fluidizes, or converts the accumulated solids on the bottom of the tank from a solid-like state to a liquid-like state. The fluidized solids may thereby be more readily drawn out of the tank 12 by the suction pump 65. Designs for stingers are conventional and known in the art. It will be appreciated that fluidization of the solid material may be enhanced by inserting and withdrawing the stinger from the tank so as to fluidize a greater volume of the solid material.

The fluidizing liquid may be supplied to the system 10 by an external or onsite tank. The fluidizing liquid may be water or oil depending on what fluid is stored in the production tank. Optionally, the accumulator tank 62 may contain an initial charge of the fluidizing liquid sufficient to initiate the operation of the system. In these embodiments, the fluidizing liquid may comprise water. In another embodiment, the fluidizing liquid may be the liquid hydrocarbon contained in the tank 12. An initial pilot amount of the liquid hydrocarbon may be drawn off the tank 12 and supplied to the system 10 so as to begin the operation of the system. It will be appreciated that the separation system 50 may be mounted on a truck or a skid for ease of transpiration to a desired location.

While specific embodiments of the invention have been described and illustrated, such embodiments should be considered illustrative of the invention only and not as limiting the invention as construed in accordance with the accompanying claims.

What is claimed is:

1. A method for removing solid materials from an oil production tank containing a liquid hydrocarbon portion and a solid portion, the method comprising
drawing off a portion of the liquid hydrocarbon and solid portions from the tank;
separating the liquid hydrocarbon and solid portions through the use of a rotational particle separator; and
collecting said separated solid portion, wherein said separated liquid hydrocarbon portion is returned to the tank.

2. The method of claim 1 wherein said separating comprises passing the liquid hydrocarbon and solid portions through a centrifuge.

3. The method of claim 1 wherein said separating comprises passing the liquid hydrocarbon and solid portions through a cyclone separator.

4. The method of claim 1 further comprising fluidizing the solid portions in the tank so as to aid said drawing.

5. The method of claim 4 wherein said fluidizing comprises injecting a stream of a fluidizing liquid proximate to a bottom of said tank.

6. The method of claim 5 where said fluidizing liquid is injected into said tank from the end of an elongate member insertable into said tank.

7. The method of claim 5 wherein said fluidizing liquid is water.

8. The method of claim 5 wherein said fluidizing liquid is the same as the liquid hydrocarbon of the tank.

9. The method of claim 8 wherein a primer amount of the liquid hydrocarbon portion is drawn from the tank and used as said fluidizing liquid.

10. The method of claim 9 further comprising accumulating the liquid portion separated from said rotational particle separator before said liquid hydrocarbon portion is returned to the tank for providing said fluidizing liquid.

10. The method of claim 1 further comprising pumping said liquid hydrocarbon portion and a solid portion from said tank to said rotational particle separator.

11. The method of claim 1 further comprising pumping said separated liquid hydrocarbon portion back to the tank.

12. A system for removing solid materials from an oil production tank containing a liquid hydrocarbon portion and a solid portion, the apparatus comprising:
an intake for drawing off a portion of the liquid hydrocarbon and a solid portions from the tank;
a rotational particle separator adapted to receive said portion of the liquid hydrocarbon and a solid portions from said intake;
a collector for collecting said separated solid portion; and
a return for returning said separated liquid hydrocarbon portion to the tank.

13. The system of claim 12 wherein said rotational particle separator comprises a centrifuge.

14. The system of claim 12 wherein said rotational particle separator comprises a cyclone separator.

15. The system of claim 12 further comprising a fluidizer for fluidizing the liquid hydrocarbon and solid portions in the tank so as to aid said drawing.

16. The system of claim 15 wherein said fluidizer comprises a stream of fluidizing liquid injected into said tank proximate to a bottom of said tank.

17. The system of claim 16 further comprising an elongate member having a distal end, said member being insertable into said tank and adapted to discharge said fluidizing liquid from said distal end.

18. The system of claim 16 wherein said fluidizing liquid is water.

19. The system of claim 16 wherein said fluidizing liquid is the same as the liquid hydrocarbon of the tank.

20. The system of claim 19 wherein a primer amount of the liquid hydrocarbon portion is drawn from the tank and used as said fluidizing liquid.

21. The system of claim 20 further including an accumulator tank for accumulating the liquid hydrocarbon portion separated from said rotational particle separator before said liquid hydrocarbon portion is returned to the tank, said accumulator tank providing said agitating liquid.

22. The system of claim 12 further comprising an intake pump for pumping said liquid hydrocarbon portion and a solid portion from said tank to said rotational particle separator.

23. The system of claim 12 further comprising a return pump for pumping said separated liquid hydrocarbon portion to the tank.

24. The system of claim 12 wherein said system is substantially mounted on a skid.

25. The system of claim 12 wherein said system is substantially mounted on a truck.
